(19) United States
(12) Patent Application Publication
(10) Pub. No.: US 2026/0170863 A1
(43) Pub. Date: Jun. 18, 2026

(54) DETECTION DEVICE, DETECTION SYSTEM, DETECTION METHOD, AND NON-TRANSITORY COMPUTER READABLE MEDIUM

(71) Applicant: NEC Corporation, Minato-ku, Tokyo (JP)

(72) Inventor: Yasufumi HIRAKAWA, Tokyo (JP)

(73) Assignee: NEC Corporation, Minato-ku, Tokyo (JP)

(21) Appl. No.: 18/709,592

(22) PCT Filed: Mar. 31, 2022
(86) PCT No.: PCT/JP2022/016583

§ 371 Date: May 13, 2024

(51) Int. Cl. G06V 40/10; G06V 10/25; G06V 20/58

(52) U.S. Cl. CPC G06V 40/10; G06V 10/25; G06V 20/58

(57) ABSTRACT

A detection device (10) includes: a stationary object determination unit (11) that determines whether or not a target object of a first category is in a stationary state in an acquired image; a surrounding object determination unit (12) that determines, in a case where it is determined that the target object is in the stationary state, whether or not a surrounding object of a second category that satisfies a predetermined condition with the target object exists in the image; and an unattended state detection unit (13) that detects that the target object is in an unattended state in a case where it is determined that no surrounding object exists for a predetermined period of time.

### TECHNICAL FIELD

The present disclosure relates to a detection device, a detection system, a detection method, and a non-transitory computer readable medium.

### BACKGROUND ART

A technology for detecting an unattended object that has been left behind from an image captured by a monitoring camera has been developed. Patent Literatures 1 to 4 are known as related technologies. For example, in Patent Literature 1, a person around a target object is tracked, and an unattended state of the target object is determined according to movement of the tracked person.

### CITATION LIST

### Patent Literature

Patent Literature 1: International Patent Publication No. WO 2018/179202

Patent Literature 2: International Patent Publication No. WO 2021/124553

Patent Literature 3: Japanese Unexamined Patent Application Publication No. 2021-114771

Patent Literature 4: Japanese Unexamined Patent Application Publication No. 2021-145164

### SUMMARY OF INVENTION

### Technical Problem

As described above, in the related technology such as Patent Literature 1, it is assumed that a specific person detected around a target object is tracked. That is, in the related technology, the owner of a target object is specified, and an unattended state of the object is detected according to a result of tracking the specified person. For this reason, with the related technology, it is difficult to detect an unattended state of an object in a case where it is not possible to specify the owner or in a case where the owner cannot be tracked.

In view of such a problem, an object of the present disclosure is to provide a detection device capable of detecting an unattended state of an object even in various situations, a detection system, a detection method, and a non-transitory computer readable medium.

### Solution to Problem

A detection device according to the present disclosure includes: stationary object determination means for determining whether or not a target object of a first category is in a stationary state in an acquired image; surrounding object determination means for determining, in a case where it is determined that the target object is in the stationary state, whether or not a surrounding object of a second category that satisfies a predetermined condition with the target object exists in the image; and unattended state detection means for detecting that the target object is in an unattended state in a case where it is determined that no surrounding object exists for a predetermined period of time.

A detection system according to the present disclosure includes: a camera; and a detection device, in which the detection device includes: stationary object determination means for determining whether or not a target object of a first category is in a stationary state in an image acquired from the camera; surrounding object determination means for determining, in a case where it is determined that the target object is in the stationary state, whether or not a surrounding object of a second category that satisfies a predetermined condition with the target object exists in the image; and unattended state detection means for detecting that the target object is in an unattended state in a case where it is determined that no surrounding object exists for a predetermined period of time.

A detection method according to the present disclosure includes: determining whether or not a target object of a first category is in a stationary state in an acquired image; determining, in a case where it is determined that the target object is in the stationary state, whether or not a surrounding object of a second category that satisfies a predetermined condition with the target object exists in the image; and detecting that the target object is in an unattended state in a case where it is determined that no surrounding object exists for a predetermined period of time.

A non-transitory computer readable medium according to the present disclosure is a non-transitory computer readable medium storing a detection program for causing a computer to execute processes of: determining whether or not a target object of a first category is in a stationary state in an acquired image; determining, in a case where it is determined that the target object is in the stationary state, whether or not a surrounding object of a second category that satisfies a predetermined condition with the target object exists in the image; and detecting that the target object is in an unattended state in a case where it is determined that no surrounding object exists for a predetermined period of time.

### Advantageous Effects of Invention

According to the present disclosure, it is possible to provide a detection device capable of detecting an unattended state of an object even in various situations, a detection system, a detection method, and a non-transitory computer readable medium.

### BRIEF DESCRIPTION OF DRAWINGS

FIG. 1 is a configuration diagram illustrating an outline of a detection device according to an example embodiment.

FIG. 2 is a configuration diagram illustrating a configuration example of an unattended object detection system according to a first example embodiment.

FIG. 3 is a diagram for describing an outline of an operation of the unattended object detection device according to the first example embodiment.

FIG. 4 is a flowchart illustrating an operation example of the unattended object detection device according to the first example embodiment.

FIG. 5 is a flowchart illustrating an operation example of a stationary object determination process according to the first example embodiment.

FIG. 6 is a flowchart illustrating an operation example of a surrounding object existence determination process according to the first example embodiment.

FIG. 7 is a diagram for describing the surrounding object existence determination process according to the first example embodiment.

FIG. 8 is a diagram for describing the surrounding object existence determination process according to the first example embodiment.

FIG. 9A is a diagram illustrating an example of determination conditions for the surrounding object existence determination process according to the first example embodiment.

FIG. 9B is a diagram illustrating an example of determination conditions for the surrounding object existence determination process according to the first example embodiment.

FIG. 9C is a diagram illustrating an example of determination conditions for the surrounding object existence determination process according to the first example embodiment.

FIG. 10 is a flowchart illustrating an operation example of a surrounding object existence management process according to the first example embodiment.

FIG. 11 is a diagram for describing the surrounding object existence management process according to the first example embodiment.

FIG. 12 is a diagram for describing the surrounding object existence management process according to the first example embodiment.

FIG. 13 is a flowchart illustrating an operation example of an alert determination process according to the first example embodiment.

FIG. 14 is a diagram illustrating a display example of the unattended object detection device according to the first example embodiment.

FIG. 15 is a configuration diagram illustrating a configuration example of an unattended object detection system according to a second example embodiment.

FIG. 16 is a flowchart illustrating an operation example of a determination region setting process according to the second example embodiment.

FIG. 17 is a diagram for describing the determination region setting process according to the second example embodiment.

FIG. 18 is a diagram for describing the determination region setting process according to the second example embodiment.

FIG. 19 is a diagram for describing the determination region setting process according to the second example embodiment.

FIG. 20 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

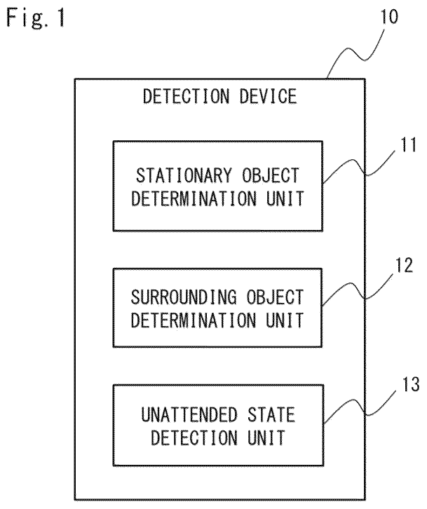

FIG. 1 illustrates an outline of a detection device according to an example embodiment. As illustrated in FIG. 1, a detection device 10 according to the example embodiment includes a stationary object determination unit 11, a surrounding object determination unit 12, and an unattended state detection unit 13.

The stationary object determination unit 11 determines whether or not a target object of a first category is in a stationary state in an acquired image. In a case where it is determined that the target object is in the stationary state, the surrounding object determination unit 12 determines whether or not a surrounding object of a second category that satisfies a predetermined condition with the target object exists in the image. In a case where it is determined that the surrounding object does not exist for a predetermined time, the unattended state detection unit 13 detects that the target object is in an unattended state.

As described above, in the example embodiment, in a case where it is determined that the target object is in the stationary state and it is determined that the surrounding object such as a person satisfying the predetermined condition does not exist for the predetermined time, it is detected that the target object is in the unattended state. Therefore, it is possible to detect an unattended object without specifying an owner of the target object or tracking the owner as in the related technology. Accordingly, it is possible to detect an unattended object even in various situations such as a case where it is not possible to specify the owner or a case where the owner cannot be tracked. In addition, since a complicated process is unnecessary, an unattended object can be easily detected.

### First Example Embodiment

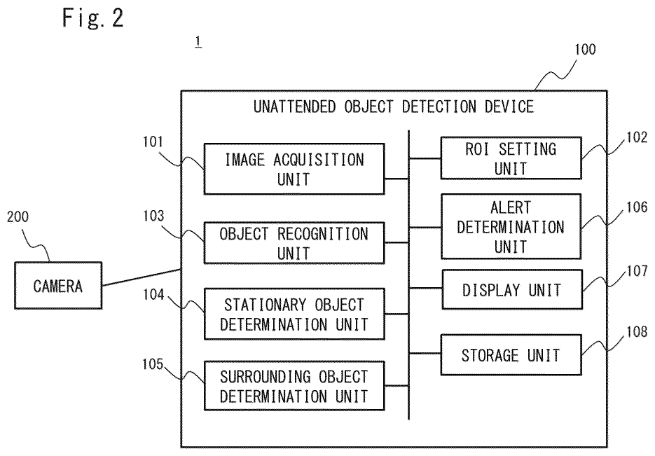

Hereinafter, a first example embodiment will be described with reference to the drawings. FIG. 2 illustrates a configuration example of an unattended object detection system according to the present example embodiment. As illustrated in FIG. 2, an unattended object detection system 1 according to the present example embodiment includes an unattended object detection device 100 and a camera 200.

The camera 200 is an imaging device such as a monitoring camera that generates a two-dimensional image. The camera 200 is installed at a predetermined location, and images an object or the like in an imaging region, for example, a monitoring region, at the installation location. The camera 200 is connected directly or via a network or the like in such a way as to be able to output a captured image to the unattended object detection device 100. Note that the camera 200 may be provided inside the unattended object detection device 100. Note that the image may indicate a video including a plurality of images.

The unattended object detection device 100 is a device that detects an unattended object that is left behind based on an image captured by the camera 200. The unattended object detection device 100 includes an image acquisition unit 101, a region-of-interest (ROI) setting unit 102, an object recognition unit 103, a stationary object determination unit 104, a surrounding object determination unit 105, an alert determination unit 106, a display unit 107, and a storage unit 108. Note that a configuration of each unit or each block is an example, and each unit or each block may be configured by other units as long as operations or methods described below are possible. Furthermore, the unattended object detection device 100 is implemented by, for example, a computer device such as a personal computer or a server that executes a program, and may be implemented by one device or a plurality of devices. For example, the storage unit 108 and the display unit 107 may be external devices.

The image acquisition unit 101 acquires a two-dimensional image captured by the camera 200. The image acquisition unit 101 acquires, for example, an image including an object in the monitoring region and captured by the camera 200 in a predetermined period. The acquisition is not limited to the acquisition from the camera 200, and may include acquisition of an image prepared in advance from a database or the like.

The ROI setting unit 102 sets a region of interest (ROI) in the acquired image. The ROI is a region where object recognition is performed in the image, and is a region where stationary object determination and surrounding object determination are performed based on the recognized object, and alert determination is performed, for example, unattended state determination for determining whether or not the object is in the unattended state is performed. The ROI may be set by a user or may be set according to the acquired image. For example, a region where a person moves may be recognized from the image, and the recognized region may be set as the ROI. As an example, it is possible to detect an object left by a passenger on a platform of a station by setting the platform as the ROI. Further, it is possible to detect an object left by a visitor by setting a visitor area of a store counter or an airport check-in counter as the ROI.

The object recognition unit 103 recognizes an object in the acquired image. The object recognition unit 103 is also an object detection unit that detects an object by performing object recognition. The object recognition unit 103 detects an object in the ROI in the image and recognizes a class of the object. The class of the object indicates a type or the like of the object. The object recognition unit 103 extracts a rectangular object region including an object from the image, that is, a bounding box, and recognizes the class of the object in the extracted object region. For example, the object recognition unit 103 recognizes an object in the image by an object recognition engine using machine learning such as deep learning. The object recognition unit 103 can recognize the object by machine learning of a feature or pattern of an image of the object and the class of the object.

The stationary object determination unit 104 performs the stationary object determination to determine whether or not the recognized object recognized in the image is in the stationary state, that is, whether or not the recognized object is a stationary object. The stationary object determination unit 104 determines a stationary state of an object of a category A (first category) among recognized objects recognized in the ROI by the object recognition unit 103, and detects a stationary object. The category A is a target object to be detected as an unattended object, and the type of the object is not limited. The target object of the category A is an object that is likely to be managed and left by a person or the like, and is, for example, a bag or the like, and may be a person, an animal, or the like. The type of the object included in the category A may be set in advance. In a case where the recognized object of the category A does not move for a certain period of time, that is, the position of the recognized object does not change, the stationary object determination unit 104 determines that the recognized object of the category A is in the stationary state, that is, the recognized object of the category A is a stationary object. For example, the stationary state may be detected by tracking the recognized object. In addition, the stationary object determination unit 104 manages the stationary state of the object by updating a stationary state counter in a case where the object is in the stationary state.

The surrounding object determination unit 105 performs the surrounding object determination to determine existence of a surrounding object satisfying a predetermined condition around the target object determined to be in the stationary state. The surrounding object determination unit 105 determines existence of a surrounding object of a category B (second category) among the recognized objects recognized in the ROI by the object recognition unit 103, and detects the surrounding object. The category B is an object that is likely to manage and leave an object of the category A, and is, for example, a person, a robot, or the like. The type of the object included in the category B may be set in advance.

The surrounding object determination unit 105 detects a surrounding object based on either or both of a distance between the target object and another unspecified object and an overlap between object regions. That is, in this example, a condition for the surrounding object is either or both of the distance to the target object and the overlap. The calculated distance is an actual distance based on a two-dimensional image, that is, an actual distance. The actual distance can be calculated using camera parameters. The camera parameters, that is, imaging parameters are parameters for converting a length in a two-dimensional image plane into a length in a three-dimensional real world space. The camera parameters include a posture, a position, an imaging angle, a focal length, and the like of the camera 200. In addition, the surrounding object determination unit 105 sets a result of determining the existence of a surrounding object, that is, a detection result, in a ring buffer that manages the existence of a surrounding object. The ring buffer is holding means that cyclically holds the result of determining the existence of a surrounding object in a predetermined determination period.

The alert determination unit 106 performs unattended state determination to determine whether or not the target object is in the unattended state as the alert determination based on the result of determining a stationary object and a surrounding object, that is, the detection result. The alert determination unit 106 is also an unattended state detection unit that detects an unattended object by unattended state determination. That is, the alert determination for determining necessity of an alert indicating the unattended state is performed. In a case where it is determined that no surrounding object exists around the target object determined to be in the stationary state for a predetermined time, the alert determination unit 106 determines that the target object is in the unattended state, that is, the alert is necessary. The alert determination unit 106 determines the unattended state of the target object based on a time during which no surrounding object exists in the predetermined determination period. The alert determination unit 106 determines that the target object is in the unattended state in a case where a proportion of the time during which no surrounding object exists around the target object in the predetermined determination period is larger than a predetermined proportion. The predetermined proportion serving as a determination reference for the unattended state may be set in advance or may be changed according to a status of the image or the like. For example, the predetermined proportion may be changed according to the number of objects such as persons included in the image.

The display unit 107 is an output unit that displays results of operations, processes, and the like of the unattended object detection device 100 on a display screen. For example, the display unit 107 is a display device such as a liquid crystal display or an organic electro luminescence (EL) display. The display unit 107 displays a determination result or the like of the alert determination unit 106 on a display screen including a GUI in such a way as to be superimposed on the image captured by the camera 200. The display unit 107 changes a display mode of the target object according to a result of determining the unattended state of the object by the alert determination unit 106. In addition, the display unit 107 may display a determination result of the stationary object determination or the surrounding object determination. The display unit 107 is an example of an output unit that outputs the result of determining the unattended state of the object, or the like. For example, the result of determining the unattended state of the object, or the like may be output by voice or other means.

The storage unit 108 stores information or data necessary for the operations and processes of the unattended object detection device 100. For example, the storage unit 108 is a non-volatile memory such as a flash memory or a hard disk device. The storage unit 108 stores the image acquired by the image acquisition unit 101, setting information of the ROI set by the ROI setting unit 102, a recognition result of the object recognition unit 103, the stationary state counter set by the stationary object determination unit 104, the ring buffer set by the surrounding object determination unit 105, the camera parameters used for calculating an actual distance between objects, and the like.

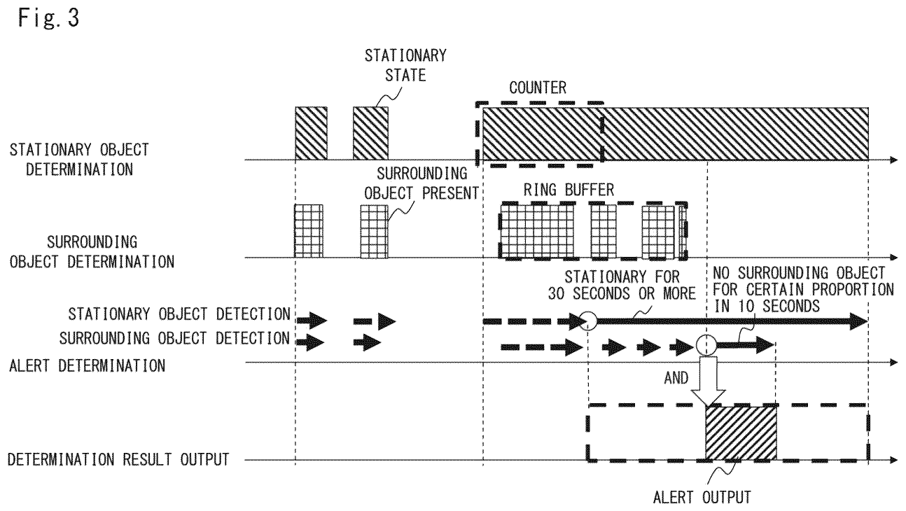

FIG. 3 illustrates an outline of an operation of the unattended object detection device according to the present example embodiment. As illustrated in FIG. 3, the unattended object detection device 100 detects the stationary state of the target object by performing the stationary object determination on the object recognized in the ROI of the image. For example, when the stationary state is detected, the stationary state counter is updated every second to manage continuation of the stationary state of the target object.

In addition, the unattended object detection device 100 detects the existence of a surrounding object by performing surrounding object determination on an object around the target object determined to be in the stationary state among the objects recognized in the ROI of the image. For example, the existence of a surrounding object in the predetermined determination period is managed by updating the ring buffer every second according to the result of determining a surrounding object.

Furthermore, the unattended object detection device 100 performs the alert determination based on a determination result of the stationary object determination and a determination result of the surrounding object determination. For example, in a case where it is determined using the stationary state counter that the target object is stationary for 30 seconds or more, and it is determined using the ring buffer that no surrounding object exists around the target object for a time of a certain proportion, for example, 70%, in 10 seconds, it is determined that the alert is necessary. Then, the display unit 107 outputs an alert indicating that the target object is in the unattended state.

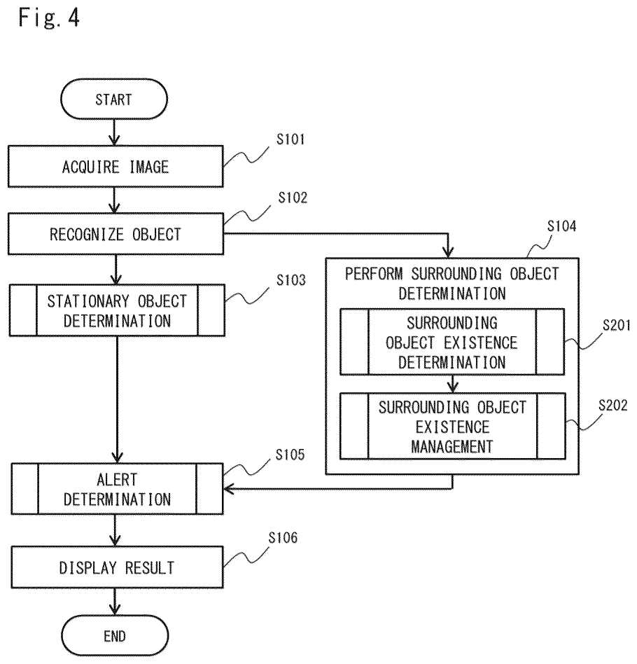

FIG. 4 illustrates an operation example of the unattended object detection device according to the present example embodiment. As illustrated in FIG. 4, the unattended object detection device 100 acquires an image from the camera 200 (S101). The camera 200 generates an image by imaging the monitoring region, and the image acquisition unit 101 acquires the captured image for unattended object detection from the camera 200.

Next, the unattended object detection device 100 recognizes an object based on the acquired image (S102). For example, the ROI setting unit 102 sets an ROI in the image, and the object recognition unit 103 recognizes an object in the ROI of the acquired image. The object to be recognized is, for example, an object of which a lower end of an object region is included in the ROI. In a case where a plurality of objects are included in the ROI, all the included objects are detected, and the class of each object is recognized. The object recognition unit 103 outputs coordinates of the rectangular object region and the recognized class of the object as a recognition result.

Next, in the unattended object detection device 100, the stationary object determination unit 104 performs a stationary object determination process (S103), and the surrounding object determination unit 105 performs a surrounding object determination process (S104). The surrounding object determination process (S104) includes a surrounding object existence determination process (S201) and a surrounding object existence management process (S202).

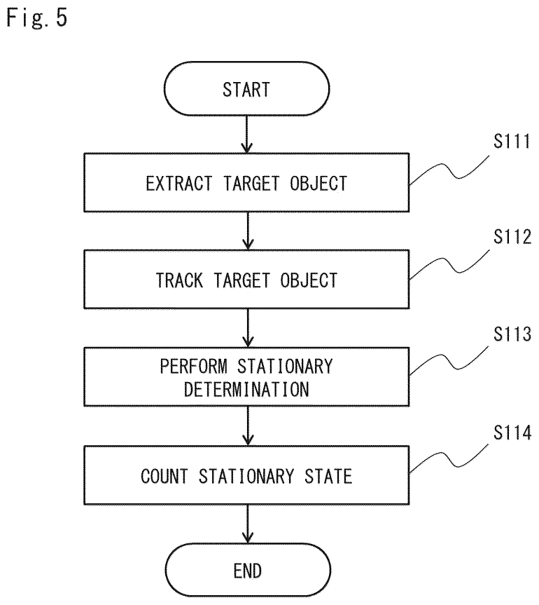

FIG. 5 illustrates an operation example of the stationary object determination process (S103) of FIG. 4. As illustrated in FIG. 5, the stationary object determination unit 104 extracts a target object to be detected as an unattended object from the recognized objects recognized in the image (S111). The stationary object determination unit 104 extracts an object of the category A as the target object by referring to the class of each recognized object.

Next, the stationary object determination unit 104 tracks the extracted target object (S112). The stationary object determination unit 104 assigns a tracking ID to each target object, and tracks the object identified by the tracking ID in each frame of the image.

Next, the stationary object determination unit 104 determines whether or not the target object is in the stationary state (S113). The stationary object determination unit 104 determines whether or not each target object tracked in each frame of the image is stationary. The stationary object determination unit 104 periodically, for example, every second, determines whether or not the coordinates of the object region of the target object in the preceding and following images, that is, frames, are the same, for example, whether or not the difference is within a predetermined range, and determines that the target object is in the stationary state in a case where the coordinates are the same. Since the object is temporarily not recognized in some cases, even when the object is not recognized for a predetermined period, it may be determined that the target object is in the stationary state on the assumption that the object is recognized.

Next, the stationary object determination unit 104 counts the stationary state according to the determination result (S114). The stationary state counter is stored in the storage unit 108 for each target object. The stationary object determination unit 104 performs stationary determination every second, and increments the stationary state counter of the corresponding target object in a case where it is determined that the target object is in the stationary state. In a case where it is determined that the target object is not in the stationary state, the stationary state counter is reset.

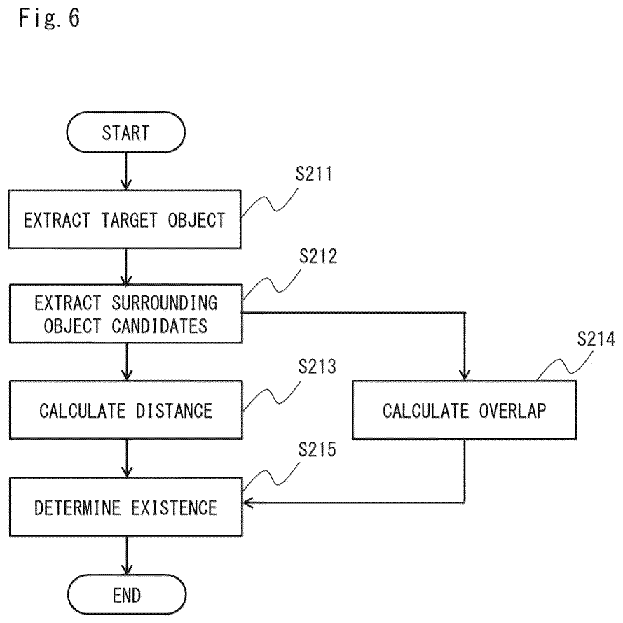

FIG. 6 illustrates an operation example of the surrounding object existence determination process (S201) of FIG. 4. As illustrated in FIG. 6, the surrounding object determination unit 105 extracts a target object to be detected as an unattended object, that is, a stationary object, from the recognized objects recognized in the image (S211). The surrounding object determination unit 105 extracts an object of the category A as the target object by referring to the class of each recognized object and extracts an object determined to be in the stationary state in the stationary object determination process. For example, the object determined to be in the stationary state is extracted by referring to the stationary state counter updated by the stationary object determination unit 104. The surrounding object determination unit 105 may perform the stationary object determination process similarly to the stationary object determination unit 104.

Next, the surrounding object determination unit 105 extracts surrounding object candidates, which are unspecified objects that are candidates for a surrounding object of the target object, from the recognized objects recognized in the image (S212). The surrounding object determination unit 105 extracts objects of the category B as the surrounding object candidates by referring to the class of each recognized object other than the target object.

Next, the surrounding object determination unit 105 calculates a distance between the target object and the surrounding object candidate (S213). The surrounding object determination unit 105 obtains an actual distance between the target object, that is, the stationary object, and each surrounding object candidate from the image. In a case where there are a plurality of target objects, an actual distance between each target object and each surrounding object candidate is obtained. For example, a distance between coordinates in a two-dimensional image, that is, between pixels, is calculated, and the calculated distance is converted into a distance in a real space with the camera parameters.

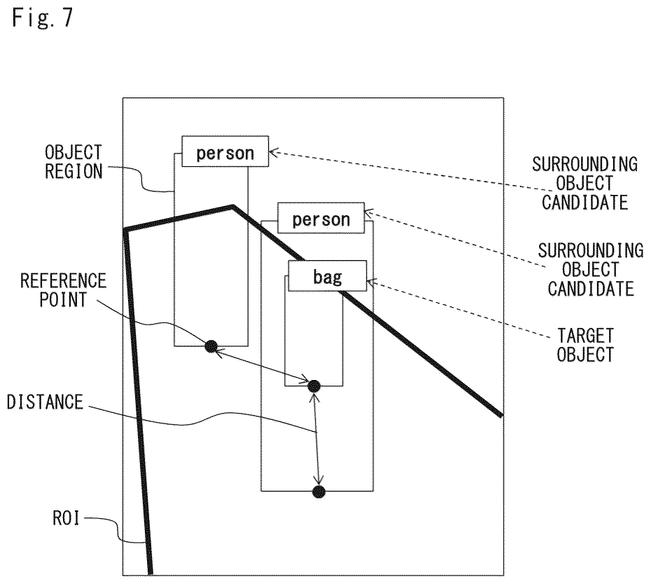

FIG. 7 illustrates an example of calculation of the distance between the target object and the surrounding object candidate. As illustrated in FIG. 7, the object region of each object is recognized in the ROI of the image, and the surrounding object determination unit 105 calculates the distance between the recognized object region of the target object and an object region of the surrounding object candidate. The surrounding object determination unit 105 calculates a distance between reference points included in rectangular object regions. For example, the reference point is a point at the center of a lower end of the rectangular region. The position of the reference point is not limited to the center of the lower end of the rectangular region, other positions of the lower end of the rectangular region or other arbitrary positions may be used as the position of the reference point. It is preferable to calculate the distance between positions having the same height in a three-dimensional real space. In a case where a lower end of an object region of a person is assumed to be in contact with the ground, for example, the floor, and the target object such as a bag is also placed on the ground, there is a possibility that the lower end of the object region is in contact with the ground. Therefore, the lower end of each object region is preferably set as the reference point. Not only the object region but also any point included in the object itself, for example, a foot of a person extracted from the feature of the object may be used as the reference point.

The surrounding object determination unit 105 calculates an overlap between the target object and the surrounding object candidate (S214). The surrounding object determination unit 105 obtains the degree of overlap and the amount of overlap between the target object in the image, that is, the stationary object, and each surrounding object candidate. In a case where there are a plurality of target objects, the degree of overlap between each target object and each surrounding object candidate is obtained.

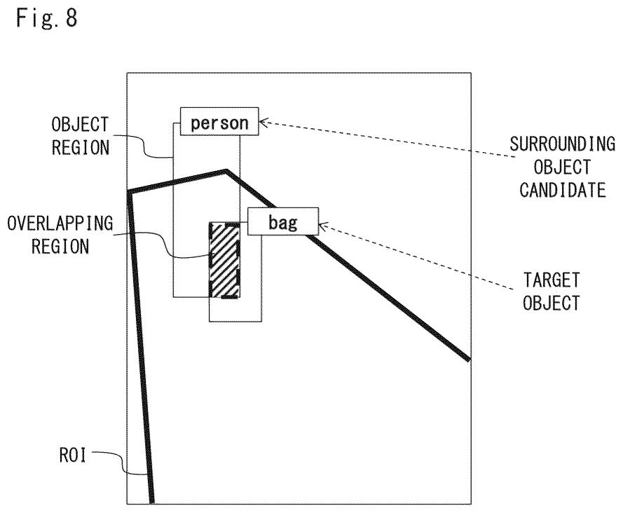

FIG. 8 illustrates an example of calculation of the overlap between the target object and the surrounding object candidate. As illustrated in FIG. 8, the object region of each object is recognized in the ROI of the image, and the surrounding object determination unit 105 calculates the degree of overlap between the recognized object region of the target object and the object region of the surrounding object candidate. For example, the surrounding object determination unit 105 obtains a ratio of an overlapping region between the object region of the target object and the object region of the surrounding object candidate to the object region of the target object. As a result, it is possible to grasp the degree of overlap between the surrounding object candidate and the target object. The intersection over union (IoU), which represents a ratio of the overlapping region to both object regions, may be obtained. In addition, not only the overlap between the object regions but also the overlap between the regions of the objects themselves, for example, the regions in contours of the objects extracted from the features of the objects, may be obtained.

Next, the surrounding object determination unit 105 determines whether or not a surrounding object exists (S215). The surrounding object determination unit 105 determines whether or not each surrounding object candidate is a surrounding object around the target object, that is, whether or not the surrounding object candidate is related to the target object, thereby determining whether or not a surrounding object exists for the target object. In a case where there are a plurality of target objects, the existence of a surrounding object is determined for each target object.

The surrounding object determination unit 105 determines whether or not the surrounding object candidate is a surrounding object by using the calculated distance and overlap between the target object and each surrounding object candidate. The surrounding object determination unit 105 may determine whether or not the object is a surrounding object based on both the distance and the overlap between the objects, or may determine whether or not the object is a surrounding object based on either one of them. In the determination based on the distance and the overlap, in a case where at least the overlap satisfies a determination criterion, it may be determined that the surrounding object candidate is a surrounding object. That is, in a case where an object such as a bag is arranged on the ground, for example, at a position higher than the floor, there is a high possibility that an error occurs in a distance between the object and a person obtained from a two-dimensional image, and thus, it is preferable to consider the overlap. In a case where the surrounding object candidate moves out of a region within a range of a predetermined distance, it may be determined that the surrounding object candidate is not a surrounding object.

For example, in a case where the distance is equal to or smaller than a certain threshold, that is, in a case where the actual distance is smaller than a predetermined value, or in a case where the overlap is larger than a certain threshold, that is, in a case where the amount of overlap is larger than a predetermined amount, the surrounding object determination unit 105 determines the surrounding object candidate as a surrounding object. The surrounding object determination unit 105 performs the determination on a plurality of surrounding object candidates to determine whether or not each of the surrounding object candidates is a surrounding object, and determines that a surrounding object exists for the target object in a case where even one surrounding object candidate determined to be a surrounding object exists. In a case where no surrounding object candidate determined to be a surrounding object exists, it is determined that no surrounding object exists for the target object.

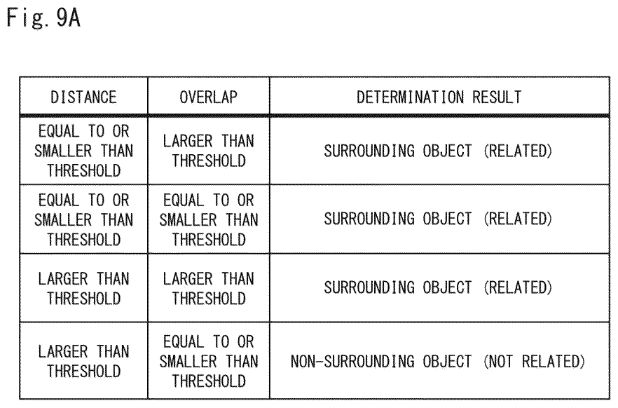

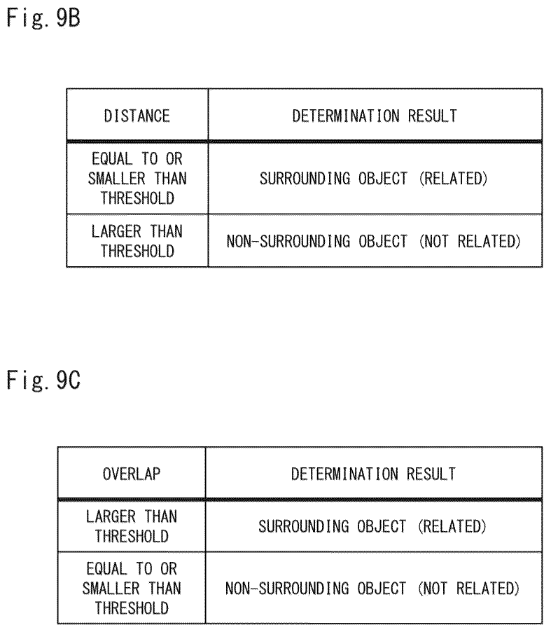

FIGS. 9A to 9C illustrate examples of determination conditions for determining whether or not the surrounding object candidate is a surrounding object, that is, whether or not the surrounding object candidate is related to the target object. FIG. 9A is an example of determining whether or not the surrounding object candidate is a surrounding object in consideration of the distance and the overlap. In this example, in a case where the distance is equal to or smaller than the certain threshold and the overlap is larger than the certain threshold, there is a high possibility that the surrounding object candidate is located near the target object from both viewpoints. Therefore, it is determined that the surrounding object candidate is a surrounding object, that is, is related to the target object.

In addition, in a case where the distance is equal to or smaller than the certain threshold and the overlap is equal to or smaller than the certain threshold, there is a possibility that the surrounding object candidate is located near the target object from the viewpoint of the distance even if the overlap does not satisfy the condition, and thus, it is determined that the surrounding object candidate is a surrounding object. In addition, in a case where the distance is larger than the certain threshold and the overlap is larger than the certain threshold, there is a possibility that the surrounding object candidate is located near the target object from the viewpoint of the overlap even if the distance does not satisfy the condition. For example, there is a possibility that the object is being carried, a person and the object overlap, or the object floats. Therefore, it is determined that the surrounding object candidate is a surrounding object. In addition, in a case where the distance is larger than the certain threshold and the overlap is equal to or smaller than the certain threshold, the surrounding object candidate is less likely to be located near the target object from either point of view, and thus, it is determined that the surrounding object candidate is not a surrounding object, that is, is not related to the target object.

FIG. 9B is an example of determining whether or not the surrounding object candidate is a surrounding object in consideration of only the distance. In this example, in a case where the distance is equal to or smaller than the certain threshold, it is determined that the surrounding object candidate is a surrounding object, and in a case where the distance is larger than the certain threshold, it is determined that the surrounding object candidate is not a surrounding object.

FIG. 9C illustrates an example of determining whether or not the surrounding object candidate is a surrounding object in consideration of only the overlap. In this example, in a case where the overlap is larger than the certain threshold, it is determined that the surrounding object candidate is a surrounding object, and in a case where the overlap is equal to or smaller than the certain threshold, it is determined that the surrounding object candidate is not a surrounding object).

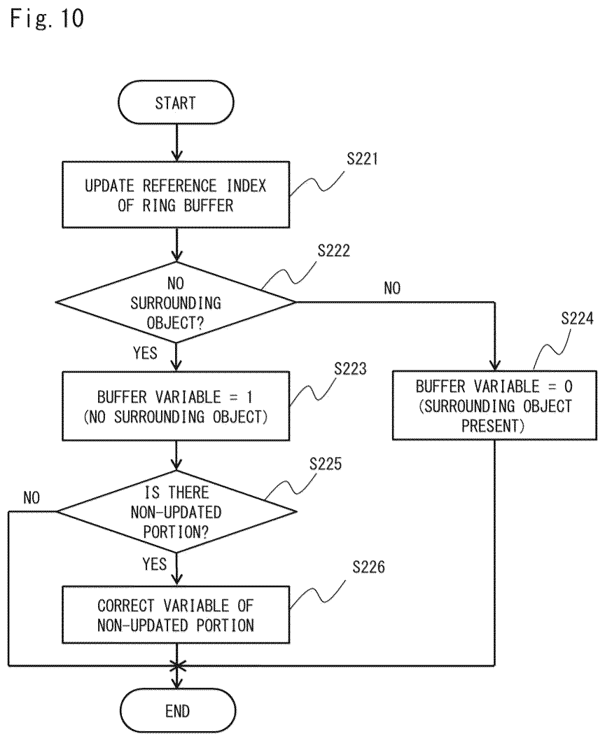

FIG. 10 illustrates an operation example of the surrounding object existence management process (S202) of FIG. 4. As illustrated in FIG. 10, the surrounding object determination unit 105 updates a reference index that refers to the ring buffer for surrounding object existence management (S221). The ring buffer is provided for each target object, and the process of S221 and subsequent processes are performed for each target object.

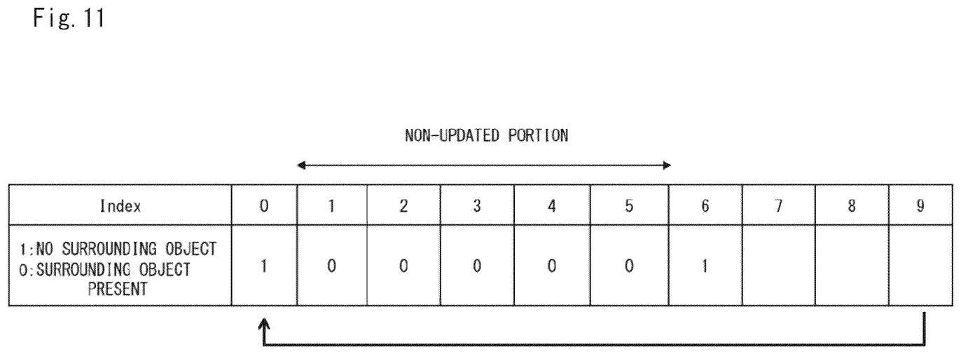

FIG. 11 illustrates a specific example of the ring buffer. The ring buffer of FIG. 11 is an example of a ring buffer that manages the existence of a surrounding object for 10 seconds. The ring buffer has a buffer variable indicating the existence of a surrounding object corresponding to each second, and each of indexes of 0 to 9 is assigned to each buffer variable. The surrounding object determination unit 105 increments the reference index that refers to the buffer variable of the ring buffer every second, and updates the buffer variable indicated by the incremented reference index in the subsequent process. In the ring buffer, in a case where the index is the maximum value, for example, 9, the index to be referred to next is 0. In this example, the buffer variable of 1 indicates that there is no surrounding object, and the buffer variable of 0 indicates that there is a surrounding object.

Next, the surrounding object determination unit 105 determines the presence or absence of a surrounding object based on a determination result of the surrounding object existence determination process described with reference to FIG. 6 (S222), and sets the buffer variable of the ring buffer according to the presence or absence of a surrounding object. In a case where it is determined that there is no surrounding object around the target object, that is, the stationary object (S222/YES), the surrounding object determination unit 105 sets the buffer variable indicated by the current reference index to 1, that is, “no surrounding object” (S223), and in a case where it is determined that there is a surrounding object around the target object (S222/NO), the buffer variable indicated by the current reference index is set to 0, that is, “surrounding object present” (S224).

In a case where the buffer variable is set to 1, the surrounding object determination unit 105 determines whether or not there is a non-updated portion, for example, a buffer variable that has not been updated from 0 to 1, among buffer variables indicated by indexes before the current reference index (S225). In a case where it is determined that there is a non-updated portion (S225/YES), the surrounding object determination unit 105 corrects the buffer variable as the non-updated portion (S226). That is, in a case where the buffer variable is changed from “surrounding object present” to “no surrounding object”, that is, in a case where the surrounding object determination result is changed, the determination result held in the ring buffer is corrected, that is, updated. The buffer variable may also be corrected in a case where the buffer variable is changed from “no surrounding object” to “surrounding object present”.

In the example of FIG. 11, when the index is 0, it is determined that there is no surrounding object and the buffer variable is 1, and when the index is 1 to 5, it is determined that there is a surrounding object and the buffer variable is 0. Next, when the index is 6, it is determined that there is no surrounding object, and the buffer variable is 1. Then, the indexes 1 to 5 between the index 0 previously updated to 1 and the index 6 currently updated to 1 have not been updated from 0 to 1, and thus are the non-updated portions. In the non-updated portions, although it is determined that there is a surrounding object, there is a possibility that the target object is temporarily not recognized. Therefore, the buffer variable is updated by regarding some of the non-updated portions as “no surrounding object”. In a case where the target object is recognized, the non-updated portions do not have to be updated.

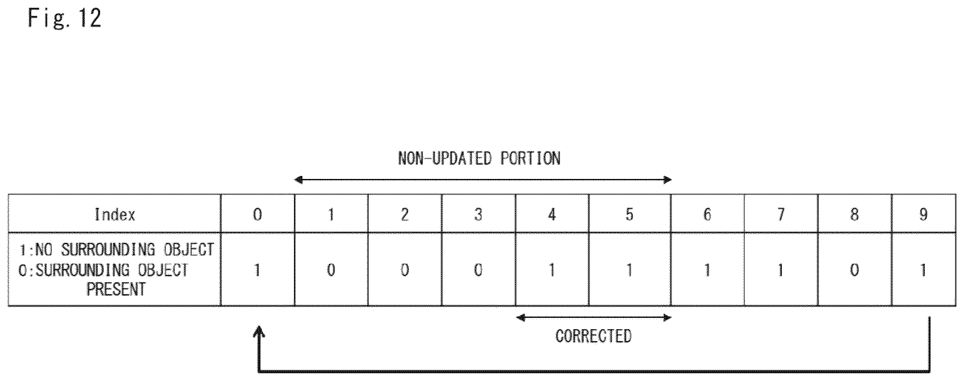

FIG. 12 illustrates a state of the ring buffer after the non-updated portion in FIG. 11 is updated. In this example, the buffer variables of the indexes 4 and 5 among the indexes 1 to 5 as the non-updated portions are updated to 1. That is, the buffer variables are updated 2 seconds back from the current index 6. The buffer variable may be updated by going back an arbitrary predetermined period from a time when the surrounding object determination result is changed. For example, the update may be performed back to a predetermined proportion of the non-updated portions.

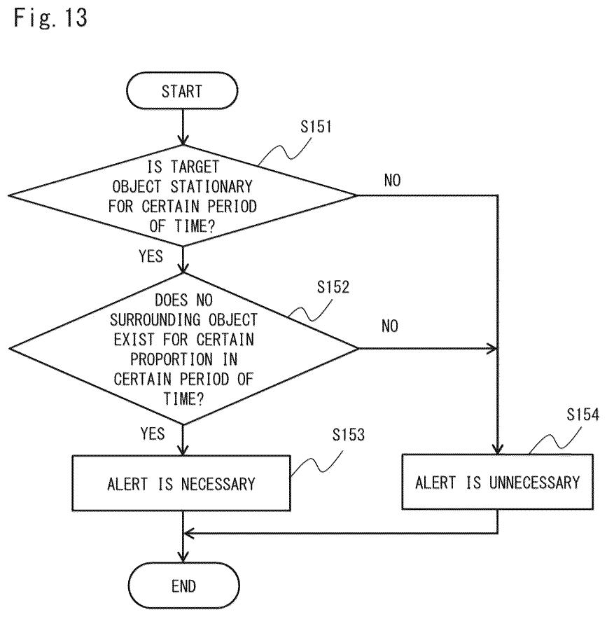

Next, as illustrated in FIG. 4, the unattended object detection device 100 performs an alert determination process (S105) based on the determination result of the stationary object determination process and the determination result of the surrounding object determination process. FIG. 13 illustrates an operation example of the alert determination process (S105) of FIG. 4.

As illustrated in FIG. 13, the alert determination unit 106 determines whether or not the target object is stationary for a certain period of time (S151). The alert determination unit 106 determines a time during which the target object is stationary based on the result of the stationary object determination process. Specifically, the alert determination unit 106 determines whether or not the value of the stationary state counter is equal to or more than the certain period of time, for example, 30 seconds, by referring to the stationary state counter updated by the stationary object determination unit 104.

Next, in a case where it is determined that the target object is stationary for the certain period of time (S151/YES), the alert determination unit 106 determines whether or not a surrounding object exists for a certain proportion in the certain period of time (S152). The alert determination unit 106 determines a proportion of a time during which a surrounding object exists around the target object based on the result of the surrounding object determination process. Specifically, the alert determination unit 106 determines whether or not a ratio of the buffer variable of 1, that is, the ratio of “no surrounding object”, to the ring buffer, for example, 10 seconds, is equal to or greater than a certain value, by referring to the ring buffer updated by the surrounding object determination unit 105.

In a case where it is determined that the target object is stationary for the certain period of time and no surrounding object exists for the certain proportion in the certain period of time (S152/YES), the alert determination unit 106 determines that the target object is in the unattended state and the alert is necessary (S153). In a case where it is determined that the target object is not stationary for the certain period of time (S151/NO) or in a case where it is determined that a surrounding object exists for the certain proportion in the certain period of time (S152/NO), it is determined that the target object is not in the unattended state and the alert is unnecessary (S154).

Next, as illustrated in FIG. 4, the unattended object detection device 100 displays a determination result of the alert determination (S106). The display unit 107 displays the unattended state of the target object on the display screen based on the alert determination result.

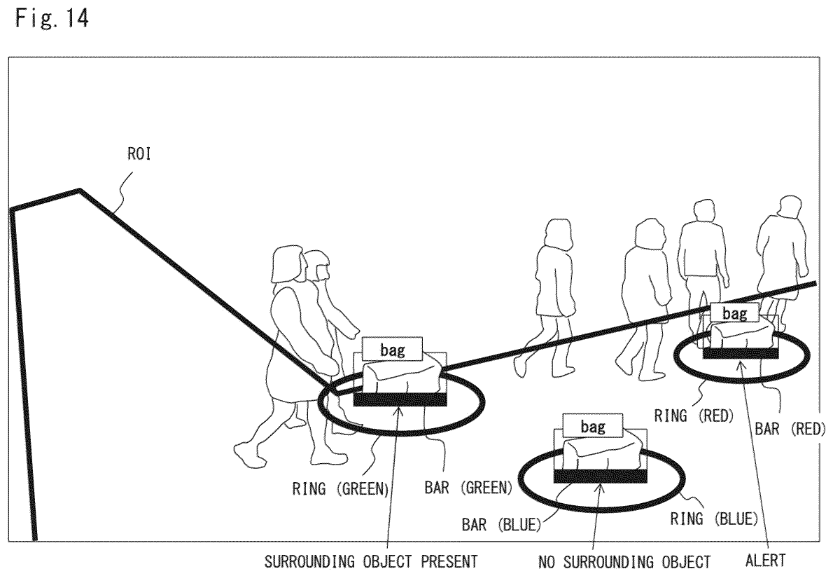

FIG. 14 illustrates a display example of the alert determination result. As illustrated in FIG. 14, the acquired image is displayed on the display screen, and the alert determination result is displayed on the image. For example, a rectangular object region in which a target object that is a bag is recognized and a class are displayed. An object region and a class of a person other than the target object may be displayed. Furthermore, in a case where the object is being tracked, a tracking ID and a tracking history, that is, a movement history, may be displayed in the object region.

In addition, the display mode of the target object is changed according to the alert determination result, that is, the unattended state determination result. The display mode is changed according to the stationary state determination result, the surrounding object existence determination result, and the unattended state determination result. For example, a bar and a ring indicating each determination result of the target object are displayed together with the target object. Both the bar and the ring may be displayed, or either one may be displayed. For example, the bar linearly highlights the lower end of the rectangular region of the object. The ring indicates a circular region of a predetermined size centered on the target object. The region of the ring corresponds to a region for detecting the existence of a surrounding object, that is, a distance threshold. A determination criterion such as a threshold may be displayed using the ring or other methods.

For example, in a case where there is no surrounding object for the target object, that is, in a case where the target object is not in the stationary state for a predetermined time, the bar and the ring are displayed in blue. In addition, in a case where there is a surrounding object for the target object, that is, in a case where the target object is in the stationary state for a predetermined time and a surrounding object exists for a predetermined time, the bar and the ring are displayed in green. In the case of an alert, that is, in a case where the target object is in the stationary state for a predetermined time and no surrounding object exists for a predetermined time, the bar and the ring are displayed in red. Note that the display of the bar and the ring is an example, and the determination result may be displayed in other shapes, sizes, colors, and the like, and the display mode may be changed according to the determination result. In addition, the shape, size, color, and the like of the target object itself may be changed according to the determination result.

As described above, in the present example embodiment, it is determined whether or not the target object is stationary, and it is determined whether or not a surrounding object exists around the target object. In a case where the target object is in a stationary state and no surrounding object exists, it is detected that the target object is an unattended object. In particular, in a case where the target object is stationary for a certain period of time and no target object exists for a certain proportion in the certain period of time, it is detected that the target object is an unattended object.

As a result, it is possible to reliably detect an unattended object in a situation where the object is left unmoved for a certain period of time and there is no person or there are few persons near the object. In a situation where the left object is managed, for example, in a situation where a person places a bag or the like on the ground and waits for a train, it is possible to prevent the placed bag from being determined as an unattended object. In particular, an unattended object is detected based on a result of determining an unspecified surrounding object, and thus, it is possible to easily detect an unattended object without specifying and tracking a surrounding person.

### Second Example Embodiment

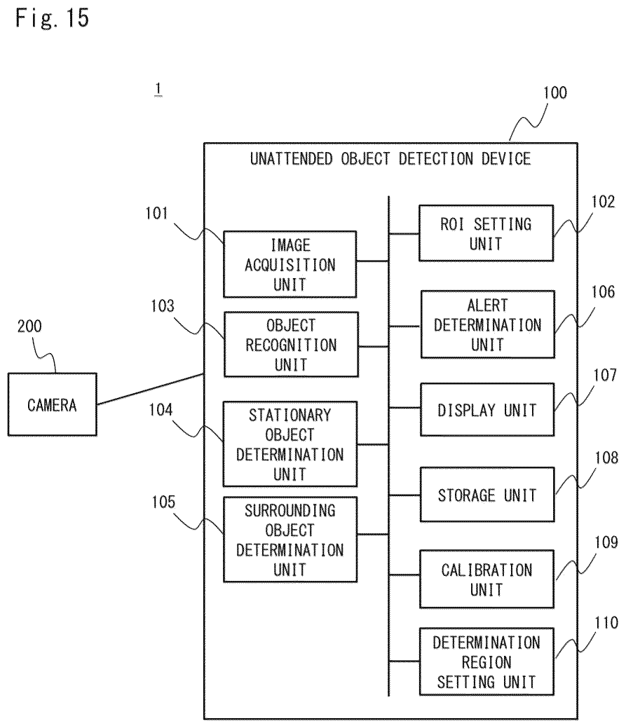

Hereinafter, a second example embodiment will be described with reference to the drawings. FIG. 15 illustrates a configuration example of an unattended object detection system according to the present example embodiment.

As illustrated in FIG. 15, an unattended object detection device 100 according to the present example embodiment further includes a calibration unit 109 and a determination region setting unit 110. Other configurations are similar to those of the first example embodiment.

The calibration unit 109 calculates camera parameters of a camera 200 based on an image acquired from the camera 200 and performs calibration. The camera parameters only need to be calculated from the acquired image, and a calculation method is not limited. For example, the calibration unit 109 calculates the camera parameters based on a plurality of line segments, that is, vectors, set on the image. The line segments used for the calculation may be set by a user or may be automatically extracted from the image. Furthermore, the camera parameters may be calculated based on lengths of the line segments on the image and a given reference length.

The determination region setting unit 110 sets a determination region in which unattended state determination, that is, alert determination, is performed or a mask region in which the unattended state determination is not performed in the image. The determination region is also a detection region for detecting an unattended state. The mask region is also a non-detection region in which the unattended state is not detected. The determination region setting unit 110 calculates an actual distance between pixels in the image by using the camera parameters obtained by the calibration, and sets the determination region or the mask region based on the calculated actual distance between the pixels. The actual distance between the pixels to be calculated is a distance representation capability per pixel.

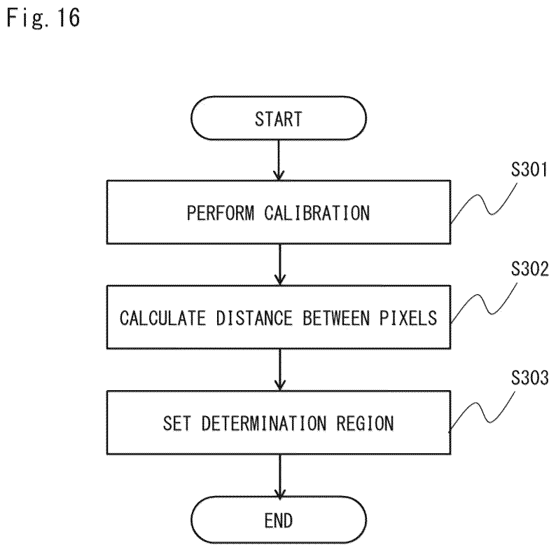

FIG. 16 illustrates an operation example of a determination region setting process according to the present example embodiment. As illustrated in FIG. 16, the unattended object detection device 100 performs calibration (S301). For example, the calibration unit 109 calculates the camera parameters based on a plurality of line segments set by the user.

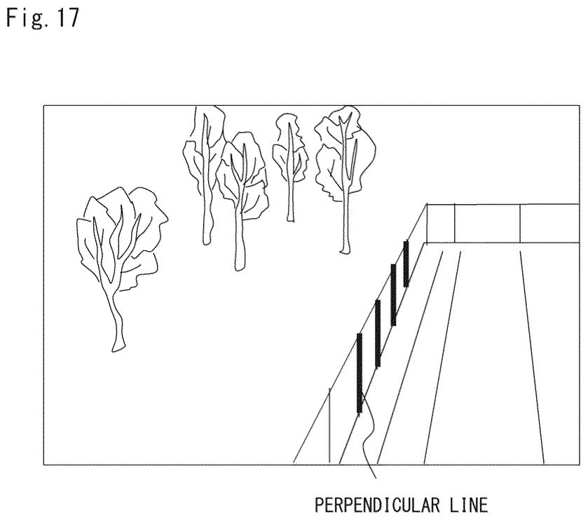

FIG. 17 illustrates a setting example at the time of calibration. As illustrated in FIG. 17, the image acquired from the camera 200 is displayed on a display screen of a display unit 107, and the user sets a plurality of perpendicular lines, for example, four perpendicular lines, perpendicular to a plane such as the ground on the image. The calibration unit 109 calculates the camera parameters based on the plurality of set perpendicular lines. For example, a posture, a position, an imaging angle, a focal length, and the like of the camera 200 are calculated as the camera parameters.

Next, the unattended object detection device 100 calculates a distance between pixels in the image (S302). The determination region setting unit 110 calculates the actual distance between the pixels in the image by using the calculated camera parameters.

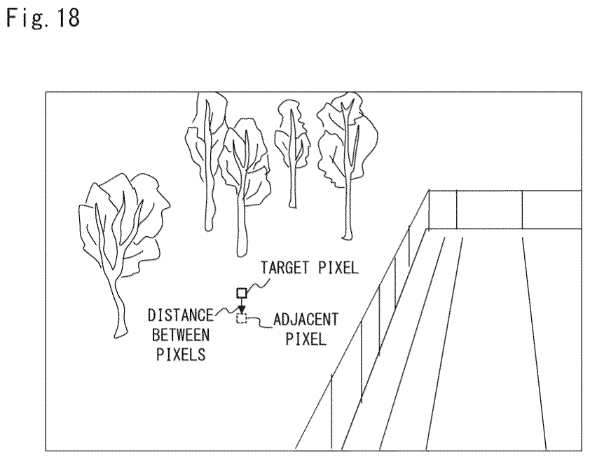

FIG. 18 illustrates an image of a distance between pixels to be calculated. As illustrated in FIG. 18, the determination region setting unit 110 calculates an actual distance between a target pixel and an adjacent pixel adjacent to the target pixel. Since a length of a real space per unit length on a two-dimensional image is longer on a lower side in the image, that is, on an upper side than a front side in the real space, that is, on a back side in the real space, an error occurring when calculating the actual distance becomes large. Therefore, the distance between the target pixel and the adjacent pixel on the lower side in the image, that is, the adjacent pixel below the target pixel, is calculated. As a result, the distance representation capability can be accurately calculated. The determination region setting unit 110 scans and sequentially selects all the pixels in the image, and calculates the actual distance between the selected target pixel and the adjacent pixel on the lower side.

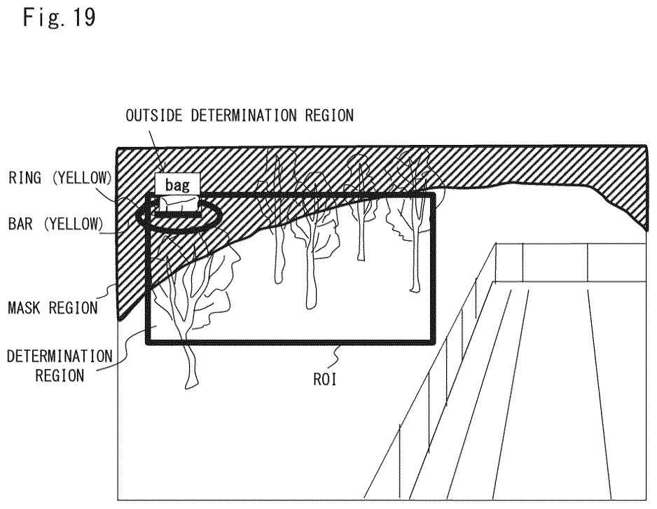

Next, the unattended object detection device 100 sets the determination region (S303). The determination region setting unit 110 sets the determination region in the image based on the calculated actual distance between the pixels, that is, the distance representation capability. FIG. 19 illustrates a setting example of the mask region. As illustrated in FIG. 19, a region in which the distance representation capability of the pixel is equal to or more than a predetermined value is set as the mask region in which the unattended state determination is not performed because an error occurring when the actual distance is calculated becomes large. In addition, a region in which the distance representation capability of the pixel is smaller than the predetermined value is set as the determination region in which the unattended state determination is performed. The predetermined value serving as a threshold can be arbitrarily set by the user. Note that a region other than the mask region in an ROI is the determination region. In the mask region, the unattended state determination, that is, the alert determination, is not performed, for example, the bar and the ring of the target object are displayed in yellow for the target object recognized in the mask region in the ROI, that is, outside the determination region.

As described above, in the present example embodiment, it is possible to set the determination region in which the unattended state determination is performed and the mask region in which the unattended state determination is not performed in the image. By setting the mask region according to the distance representation capability of the pixel, it is possible to prevent erroneous determination and erroneous detection of the unattended state.

Note that the present disclosure is not limited to the above-described example embodiments, and can be appropriately modified without departing from the scope.

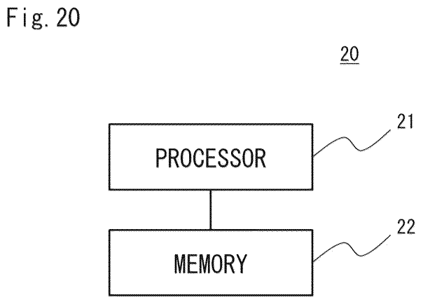

The configuration in each of the above-described example embodiments may be implemented by hardware, software, or both, and may be implemented by one piece of hardware or software or by a plurality of pieces of hardware or software. Each device (the unattended object detection device or the like) and each function (process) may be implemented by a computer 20 including a processor 21 such as a central processing unit (CPU) and a memory 22 which is a storage device as illustrated in FIG. 20. For example, programs for performing the methods (the unattended object detection method and the like) in the example embodiments may be stored in the memory 22 and the functions may be implemented by the processor 21 executing the programs stored in the memory 22.

These programs include a command group (or software codes) for causing the computer to perform one or more functions that have been described in the example embodiments in a case where the program is read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer readable medium or a communication medium. As an example and not by way of limitation, the transitory computer readable medium or the communication medium includes propagated signals in electrical, optical, acoustic, or any other form.

Although the present disclosure has been described above with reference to the example embodiments, the present disclosure is not limited to the above-described example embodiments. Various modifications that can be understood by those skilled in the art can be made to the configuration and details of the present disclosure within the scope of the present disclosure.

Some or all of the above-described example embodiments can be described as in the following Supplementary Notes, but are not limited to the following Supplementary Notes.

### Supplementary Note 1

A detection device including:
stationary object determination means for determining whether or not a target object of a first category is in a stationary state in an acquired image;
surrounding object determination means for determining, in a case where it is determined that the target object is in the stationary state, whether or not a surrounding object of a second category that satisfies a predetermined condition with the target object exists in the image; and
unattended state detection means for detecting that the target object is in an unattended state in a case where it is determined that no surrounding object exists for a predetermined period of time.

### Supplementary Note 2

The detection device according to Supplementary Note 1, in which the surrounding object determination means determines whether or not a surrounding object candidate that is a candidate for the surrounding object is the surrounding object based on a distance between the target object and the surrounding object candidate in the image, or an overlap between an object region including the target object and an object region including the surrounding object candidate in the image.

### Supplementary Note 3

The detection device according to Supplementary Note 2, in which the surrounding object determination means determines whether or not the surrounding object candidate is the surrounding object based on the distance between the target object and the surrounding object candidate and the overlap between the object region of the target object and the object region of the surrounding object candidate, and determines that the surrounding object candidate is the surrounding object in a case where at least the overlap satisfies a determination criterion.

### Supplementary Note 4

The detection device according to Supplementary Note 2 or 3, in which the surrounding object determination means determines that the surrounding object candidate is the surrounding object in a case where an amount of overlap between the object region of the target object and the object region of the surrounding object candidate is larger than a predetermined amount.

### Supplementary Note 5

The detection device according to Supplementary Note 4, in which the amount of overlap is a ratio of an overlapping region between the object region of the target object and the object region of the surrounding object candidate to the object region of the target object.

### Supplementary Note 6

The detection device according to any one of Supplementary Notes 2 to 5, in which the surrounding object determination means determines that the surrounding object candidate is the surrounding object in a case where an actual distance between the target object and the surrounding object candidate calculated from the image is smaller than a predetermined value.

### Supplementary Note 7

The detection device according to Supplementary Note 6, in which the surrounding object determination means determines that the surrounding object candidate is not the surrounding object in a case where the surrounding object candidate moves out of a region corresponding to the actual distance of the predetermined value in the image.

### Supplementary Note 8

The detection device according to any one of Supplementary Notes 2 to 7, in which a distance between the target object and the surrounding object candidate is a distance between a predetermined point in the object region of the target object and a predetermined point in the object region of the surrounding object candidate.

### Supplementary Note 9

The detection device according to Supplementary Note 8, in which the distance between the target object and the surrounding object candidate is a distance between a point at a lower end of the object region of the target object and a point at a lower end of the object region of the surrounding object candidate.

### Supplementary Note 10

The detection device according to any one of Supplementary Notes 1 to 9, in which the unattended state detection means detects that the target object is in the unattended state in a case where a proportion of a time during which no surrounding object exists in a predetermined determination period is larger than a predetermined proportion.

### Supplementary Note 11

The detection device according to Supplementary Note 10, in which the predetermined proportion is a proportion corresponding to the number of objects included in the image.

### Supplementary Note 12

The detection device according to Supplementary Note 10 or 11, further including holding means for holding a determination result for the surrounding object in the predetermined determination period, in which the unattended state detection means detects the unattended state of the target object based on the determination result held by the holding means.

### Supplementary Note 13

The detection device according to Supplementary Note 12, in which the holding means is a ring buffer that cyclically holds the determination result in the predetermined determination period.

### Supplementary Note 14

The detection device according to Supplementary Note 12 or 13, in which the surrounding object determination means corrects the determination result held by the holding means in a case where the determination result for the surrounding object is changed.

### Supplementary Note 15

The detection device according to Supplementary Note 14, in which the surrounding object determination means corrects the determination result held by the holding means by going back a predetermined period from a time when the determination result for the surrounding object is changed.

### Supplementary Note 16

The detection device according to Supplementary Note 14 or 15, in which the surrounding object determination means corrects the determination result held by the holding means in a case where the determination result for the surrounding object is changed from surrounding object present to no surrounding object.

### Supplementary Note 17

The detection device according to any one of Supplementary Notes 1 to 16, in which
the stationary object determination means determines the stationary state of the target object based on an object recognized in a region of interest set in the image, and
the surrounding object determination means determines existence of the surrounding object based on the object recognized in the region of interest.

### Supplementary Note 18

The detection device according to any one of Supplementary Notes 1 to 17, further including display means for displaying a detection result for the unattended state of the target object in a superimposed manner on the image.

### Supplementary Note 19

The detection device according to Supplementary Note 18, in which the display means changes a display mode of the target object according to the detection result for the unattended state of the target object.

### Supplementary Note 20

The detection device according to Supplementary Note 18 or 19, in which the display means further displays a determination result for the stationary state of the target object and a determination result for the existence of the surrounding object.

### Supplementary Note 21

The detection device according to any one of Supplementary Notes 1 to 20, further including setting means for setting a detection region in which the unattended state of the target object is detected or a non-detection region in which the unattended state of the target object is not detected in the image.

### Supplementary Note 22

The detection device according to Supplementary Note 21, in which the setting means sets the detection region or the non-detection region according to a distance representation capability per pixel in the image.

### Supplementary Note 23

The detection device according to Supplementary Note 22, in which the distance representation capability is an actual distance between a target pixel and an adjacent pixel in the image.

### Supplementary Note 24

The detection device according to Supplementary Note 23, in which the adjacent pixel is a pixel below the target pixel in the image.

### Supplementary Note 25

A detection system including:
a camera; and
in which the detection device includes:
stationary object determination means for determining whether or not a target object of a first category is in a stationary state in an image acquired from the camera;
surrounding object determination means for determining, in a case where it is determined that the target object is in the stationary state, whether or not a surrounding object of a second category that satisfies a predetermined condition with the target object exists in the image; and
unattended state detection means for detecting that the target object is in an unattended state in a case where it is determined that no surrounding object exists for a predetermined period of time.

### Supplementary Note 26

The detection system according to Supplementary Note 25, in which the surrounding object determination means determines whether or not a surrounding object candidate that is a candidate for the surrounding object is the surrounding object based on a distance between the target object and the surrounding object candidate in the image, or an overlap between an object region including the target object and an object region including the surrounding object candidate in the image.

### Supplementary Note 27

A detection method comprising:
determining whether or not a target object of a first category is in a stationary state in an acquired image;
determining, in a case where it is determined that the target object is in the stationary state, whether or not a surrounding object of a second category that satisfies a predetermined condition with the target object exists in the image; and
detecting that the target object is in an unattended state in a case where it is determined that no surrounding object exists for a predetermined period of time.

### Supplementary Note 28

The detection method according to Supplementary Note 27, in which in the determining for the surrounding object, it is determined whether or not a surrounding object candidate that is a candidate for the surrounding object is the surrounding object based on a distance between the target object and the surrounding object candidate in the image, or an overlap between an object region including the target object and an object region including the surrounding object candidate in the image.

### Supplementary Note 29

A non-transitory computer readable medium storing a detection program for causing a computer to execute processes of:
determining whether or not a target object of a first category is in a stationary state in an acquired image;
determining, in a case where it is determined that the target object is in the stationary state, whether or not a surrounding object of a second category that satisfies a predetermined condition with the target object exists in the image; and
detecting that the target object is in an unattended state in a case where it is determined that no surrounding object exists for a predetermined period of time.

### Supplementary Note 30

The non-transitory computer readable medium of Supplementary Note 29, in which in the determining for the surrounding object, it is determined whether or not a surrounding object candidate that is a candidate for the surrounding object is the surrounding object based on a distance between the target object and the surrounding object candidate in the image, or an overlap between an object region including the target object and an object region including the surrounding object candidate in the image.

### REFERENCE SIGNS LIST

1 UNATTENDED OBJECT DETECTION SYSTEM
10 DETECTION DEVICE
11 STATIONARY OBJECT DETERMINATION UNIT
12 SURROUNDING OBJECT DETERMINATION UNIT
13 UNATTENDED STATE DETECTION UNIT
20 COMPUTER
21 PROCESSOR
22 MEMORY
100 UNATTENDED OBJECT DETENTION DEVICE
101 IMAGE ACQUISITION UNIT
102 ROI SETTING UNIT
103 OBJECT RECOGNITION UNIT
104 STATIONARY OBJECT DETERMINATION UNIT
105 SURROUNDING OBJECT DETERMINATION UNIT
106 ALERT DETERMINATION UNIT
107 DISPLAY UNIT
108 STORAGE UNIT
109 CALIBRATION UNIT
110 DETERMINATION REGION SETTING UNIT
200 CAMERA

What is claimed is:

1. A detection device comprising:
at least one memory storing instructions, and at least one processor configured to execute the instructions stored in the at least one memory to;
determine whether or not a target object of a first category is in a stationary state in an acquired image;
determine, in a case where it is determined that the target object is in the stationary state, whether or not a surrounding object of a second category that satisfies a predetermined condition with the target object exists in the image; and
detect that the target object is in an unattended state in a case where it is determined that no surrounding object exists for a predetermined period of time.

2. The detection device according to claim 1, wherein the at least one processor is further configured to execute the instructions stored in the at least one memory to determine whether or not a surrounding object candidate that is a candidate for the surrounding object is the surrounding object based on a distance between the target object and the surrounding object candidate in the image, or an overlap between an object region including the target object and an object region including the surrounding object candidate in the image.

3. The detection device according to claim 2, wherein the at least one processor is further configured to execute the instructions stored in the at least one memory to determine whether or not the surrounding object candidate is the surrounding object based on the distance between the target object and the surrounding object candidate and the overlap between the object region of the target object and the object region of the surrounding object candidate, and determine that the surrounding object candidate is the surrounding object in a case where at least the overlap satisfies a determination criterion.

4. The detection device according to claim wherein the at least one processor is further configured to execute the instructions stored in the at least one memory to determine that the surrounding object candidate is the surrounding object in a case where an amount of overlap between the object region of the target object and the object region of the surrounding object candidate is larger than a predetermined amount.

5. The detection device according to claim 4, wherein the amount of overlap is a ratio of an overlapping region between the object region of the target object and the object region of the surrounding object candidate to the object region of the target object.

6. The detection device according to claim 2, wherein the at least one processor is further configured to execute the instructions stored in the at least one memory to determine that the surrounding object candidate is the surrounding object in a case where an actual distance between the target object and the surrounding object candidate calculated from the image is smaller than a predetermined value.

7. The detection device according to claim 6, wherein the at least one processor is further configured to execute the instructions stored in the at least one memory to determine that the surrounding object candidate is not the surrounding object in a case where the surrounding object candidate moves out of a region corresponding to the actual distance of the predetermined value in the image.

8. The detection device according to claim 2, wherein a distance between the target object and the surrounding object candidate is a distance between a predetermined point in the object region of the target object and a predetermined point in the object region of the surrounding object candidate.

9. The detection device according to claim 8, wherein the distance between the target object and the surrounding object candidate is a distance between a point at a lower end of the object region of the target object and a point at a lower end of the object region of the surrounding object candidate.

10. The detection device according to claim 1, wherein the at least one processor is further configured to execute the instructions stored in the at least one memory to detect that the target object is in the unattended state in a case where a proportion of a time during which no surrounding object exists in a predetermined determination period is larger than a predetermined proportion.

11. The detection device according to claim 10, wherein the predetermined proportion is a proportion corresponding to the number of objects included in the image.

12. The detection device according to claim 10 wherein the at least one processor is further configured to execute the instructions stored in the at least one memory to hold a determination result for the surrounding object in the predetermined determination period, and
detect the unattended state of the target object based on the determination result held by the holding means.

13. The detection device according to claim 12, further comprising a ring buffer that cyclically holds the determination result in the predetermined determination period.

14. The detection device according to claim 12, wherein the at least one processor is further configured to execute the instructions stored in the at least one memory to correct the held determination result in a case where the determination result for the surrounding object is changed.

15. The detection device according to claim 14, wherein the at least one processor is further configured to execute the instructions stored in the at least one memory to correct the held determination result by the holding means by going back a predetermined period from a time when the determination result for the surrounding object is changed.

16. The detection device according to claim wherein the at least one processor is further configured to execute the instructions stored in the at least one memory to correct the held determination result in a case where the determination result for the surrounding object is changed from surrounding object present to no surrounding object.

17. The detection device according to claim 1, wherein the at least one processor is further configured to execute the instructions stored in the at least one memory to
determine the stationary state of the target object based on an object recognized in a region of interest set in the image, and
determine existence of the surrounding object based on the object recognized in the region of interest.

18. The detection device according to claim 1, wherein the at least one processor is further configured to execute the instructions stored in the at least one memory to display a detection result for the unattended state of the target object in a superimposed manner on the image.

19-26. (canceled)

27. A detection method comprising:
determining whether or not a target object of a first category is in a stationary state in an acquired image;
determining, in a case where it is determined that the target object is in the stationary state, whether or not a surrounding object of a second category that satisfies a predetermined condition with the target object exists in the image; and
detecting that the target object is in an unattended state in a case where it is determined that no surrounding object exists for a predetermined period of time.

28. (canceled)

29. A non-transitory computer readable medium storing a detection program for causing a computer to execute processes of:
determining whether or not a target object of a first category is in a stationary state in an acquired image;
determining, in a case where it is determined that the target object is in the stationary state, whether or not a surrounding object of a second category that satisfies a predetermined condition with the target object exists in the image; and
detecting that the target object is in an unattended state in a case where it is determined that no surrounding object exists for a predetermined period of time.

30. (canceled)
